(19) United States
(12) Patent Application Publication
(10) Pub. No.: US 2007/0108801 A1
(43) Pub. Date: May 17, 2007

(54) Transformable truck bed

(75) Inventors: Keijo J. Huotari, Fenton, MI (US); Alex Laursen, Berkley, MI (US); Greg Walton, Bradford (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/581,029

(22) Filed: Oct. 13, 2006

Related U.S. Application Data
(60) Provisional application No. 60/726,262, filed on Oct. 13, 2005.

(51) Int. Cl. B62D 33/02

(52) U.S. Cl. 296/183.1

(57) ABSTRACT

A transformable truck bed is provided where the bed is enclosed by side walls that are removable so that a gooseneck mechanism could be used without being obstructed by the side walls. When the transformable bed is in the first position, or the base position, the insert side walls are removed. However, the base side walls are permanent and remain in place. Thus, the base side walls do enclose the bed but at a lower height than the insert side walls. In this position the transformable bed is capable of towing a trailer by using a gooseneck mechanism.

### CROSS-REFERENCE TO RELATED APPLICATIONS

This application claims the benefit of U.S. Provisional Application No. 60/726,262, filed Oct. 13, 2005.

### FIELD OF THE INVENTION

The present invention relates to transformable truck bed where the sides that enclose the truck bed can be inserted, removed, or altered in order to accommodate transporting various objects.

### BACKGROUND OF THE INVENTION

In recent years, the demand for trucks having the ability to tow and haul large loads has increased greatly. As a result, many manufacturers have begun to produce vehicles which have increased amount of towing capacity. Although commercial semi-trucks typically have the highest towing capacity available, these types of trucks are often uncomfortable to ride in. One way to achieve this high towing capacity, while still having increased level of comfort is through a commercial semi-truck that has been converted to have the comfort features of a conventional light-duty pickup truck. Combining the comfort features of a light-duty pickup truck with the robustness and towing capacity of a typical commercial semi-truck has substantially achieved the goal of having a truck which is capable of towing extremely high loads. An example of this is the CXT model truck, made by International Truck and Engine Corporation.

These types of trucks are capable of towing different types of trailers. In addition, these trucks can tow trailers by using various types of trailer hitches. For example, the truck can tow a trailer using a conventional trailer hitch located at the rear end of the vehicle, or a “gooseneck” type of trailer hitch which is typically attached to the bed of the pickup truck. However, it can be inconvenient for a user to purchase a truck which has the capability to accommodate a gooseneck hitch because these types of trucks often have a pickup bed with a reduced height which cannot transport cargo very easily. Typically, the truck designed for a gooseneck trailer hitch has a bed which does not have side walls, or will be equipped with short side walls which provide minimal enclosure of the pickup bed, limiting the type of cargo that can be transported.

By contrast, a truck that is not equipped for use with a gooseneck trailer hitch usually has side walls of considerable height substantially enclosing the bed, which increases the ability of the user to transport cargo in the bed. In order to tow a trailer having a gooseneck hitch, such as a fifth wheel trailer, one must have a truck where there are no obstructions surrounding the connection point between the gooseneck hitch and the truck so that the trailer can rotate freely with respect to the truck when performing various driving operations, such as maneuvering a turn. When used with a gooseneck trailer hitch, the truck cannot have obstructions blocking the movement of the gooseneck hitch, such as side walls to a pickup bed. Thus, the user of these vehicles is forced to decide what type of towing mechanism and side walls to use at the time of purchase. Essentially, the user must decide whether they are going to purchase a truck that has higher side walls for transporting cargo in the bed, or a truck that is designed differently to accommodate a gooseneck mechanism. Thus, if a user wishes to tow trailers using a gooseneck mechanism as well as transport various cargo, then the user must purchase two different trucks having these capabilities.

It would therefore be desirable to create a bed where the user could have the capability of attaching a trailer having a gooseneck trailer hitch, but also have sidewalls enclosing the bed when the trailer having the gooseneck trailer hitch is not in use.

### SUMMARY OF THE INVENTION

The present invention is a transformable truck bed having at least one base side wall, a bed connected to the base side wall, and at least one insert side wall operably associated with the base side wall.

The insert side wall is selectively engageable with the base side wall where the insert side wall will increase the overall height of the base side wall relative to the bed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a is a perspective view of a transformable truck bed in a first position, according to the present invention;

FIG. 1b is a side view of a transformable truck bed in a first position with the base tailgate folded down, according to the present invention;

FIG. 1c is a rear view of a transformable truck bed in a first position, according to the present invention;

FIG. 2 is a perspective view of a base side wall used in a transformable truck bed, according to the present invention;

FIG. 3a is a perspective view of a cap having a series of holes, used with a transformable truck bed, according to the present invention;

FIG. 3b is a side view of a cap used with a transformable truck bed, according to the present invention;

FIG. 4 is a sectional side view of a cap having a rod inserted into a receiving hole and held in place by a pin, used in a transformable truck bed, according to the present invention;

FIG. 5a is a first side view of a pin shaft assembly along with a cap having a rod for securing the cap in place, used in a transformable truck bed assembly, according to the present invention;

FIG. 5b is a second side view of a pin shaft assembly for securing a cap to a base side wall used in a transformable truck bed assembly, according to the present invention;

FIG. 6a is a perspective view of a transformable truck bed in a second position, according to the present invention;

FIG. 6b is a side view of a transformable truck bed in a second position, according to the present invention;

FIG. 6c is a rear view of a transformable truck bed assembly in a second position, according to the present invention;

FIG. 7 is a perspective view of the insert side wall and an insert tail gate used in a transformable truck bed assembly, according to the present invention;

FIG. 8 is a perspective view of a first alternate embodiment of an insert side wall used in a transformable truck bed assembly, according to the present invention;

FIG. 9a is a side view of a second alternate embodiment of a transformable truck bed assembly in a first position, according to the present invention;

FIG. 9b is a side view of a second alternate embodiment of a transformable truck bed assembly in a second position, according to the present invention;

FIG. 9c is a perspective view of a second alternate embodiment of a transformable truck bed assembly in a first position, according to the present invention;

FIG. 9d is a perspective view of a second alternate embodiment of a transformable truck bed assembly in a second position, according to the present invention;

FIG. 10 is a perspective view of a third alternate embodiment of a transformable truck bed assembly, according to the present invention;

FIG. 11a is side view of a fourth alternate embodiment of a transformable truck bed assembly in a first position, according to the present invention;

FIG. 11b is a perspective fourth view of a third alternate embodiment of a transformable truck bed assembly in a first position, according to the present invention;

FIG. 11c is a side view of a fourth embodiment of a transformable truck bed assembly changing from a first position to a second position, according to the present invention;

FIG. 11d is a side view of a fourth alternate embodiment of a transformable truck bed assembly in a second position, according to the present invention;

FIG. 11e is a perspective view of a fourth embodiment of a transformable truck bed assembly in a second position, according to the present invention;

FIG. 12a is a side view of a fifth alternate embodiment of a transformable truck bed assembly in a first position, according to the present invention; and

FIG. 12b is an enlarged side view of a fifth alternate embodiment of a transformable truck bed assembly in a second position, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

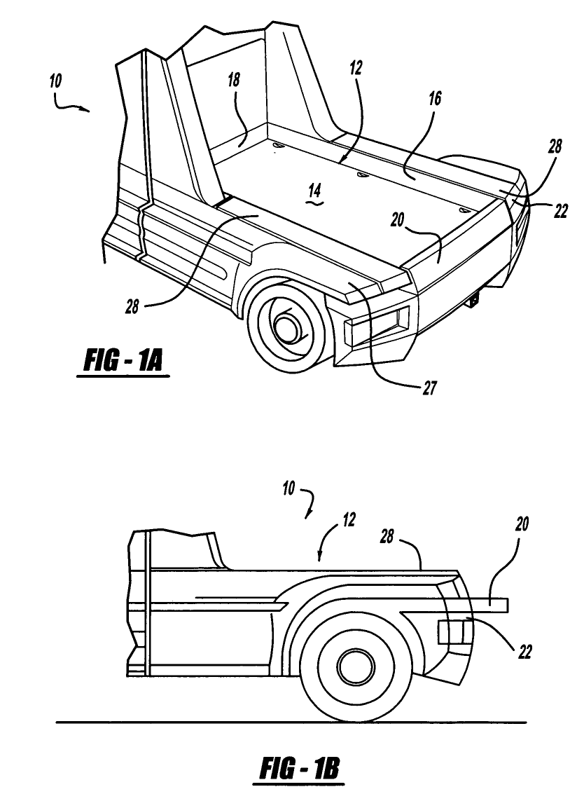

Referring to FIGS 1a-1c, a truck 10 having a transformable truck bed 12 is shown in its stowed position, or first position. The truck 10 incorporating the present invention is larger in size than a conventional, light-duty pickup truck, and is used for towing extremely large loads. This type of truck 10 is typically a commercial semi-truck which incorporates various features of light-duty trucks to have the comfort level of a light-duty truck, as well as the robustness and towing capacity of a commercial semi-truck.

When the transformable truck bed 12 is in the first position, it has a bed 14, base side walls 16, a base front wall 18, and a base tailgate 20. It is preferred that the base side walls 16 and the base tailgate 20 only extend a couple of inches above the bed 14 so that they do not extend to high and obstruct objects such as a trailer (not shown) being towed by a gooseneck trailer hitch (not shown) when the truck 10 is being used to tow a trailer. The base tailgate 20 connects to the base side walls 16 by a primary hinge (not shown) that is located at each end of the base tailgate 20, connecting the tailgate 20 to the bed 14. Therefore, the base tailgate 20 can pivot about the primary hinges, allowing the base tailgate 20 to either be in an upright position, as shown in FIGS. 1a or 1c, or a lowered position, where the base tailgate 20 creates a flat surface with the bed 14, as shown in FIG. 1b. The primary hinge could be a pin and locator, or any other type device for allowing the base tailgate 20 to pivot relative to the bed 14. It is preferred that the base tailgate 20 is flush with a tail end 22 of the truck 10 when the base tailgate 20 is in the first position so as to create an aesthetically pleasing surface at the rear of the vehicle 10.

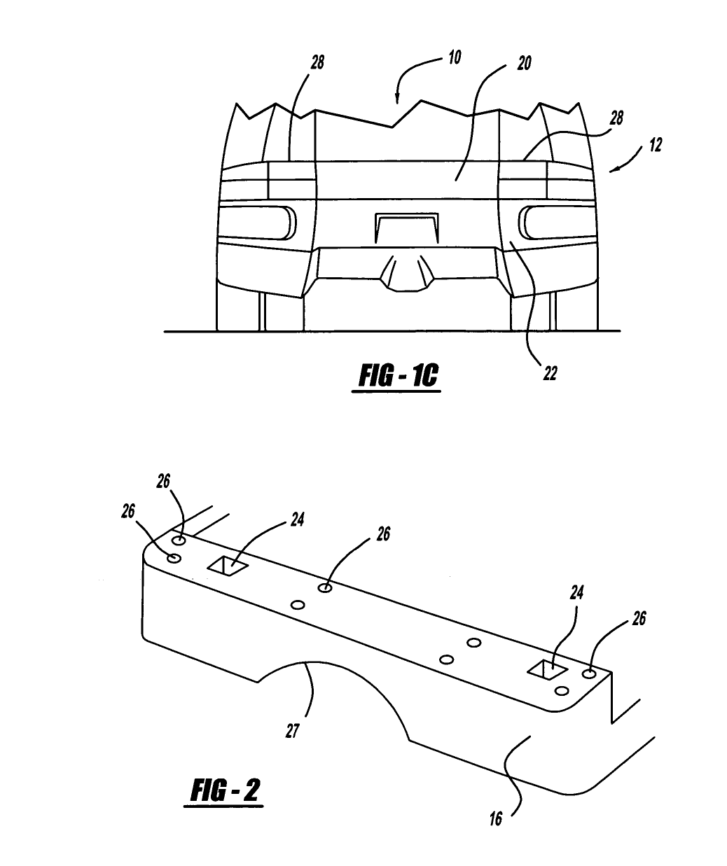

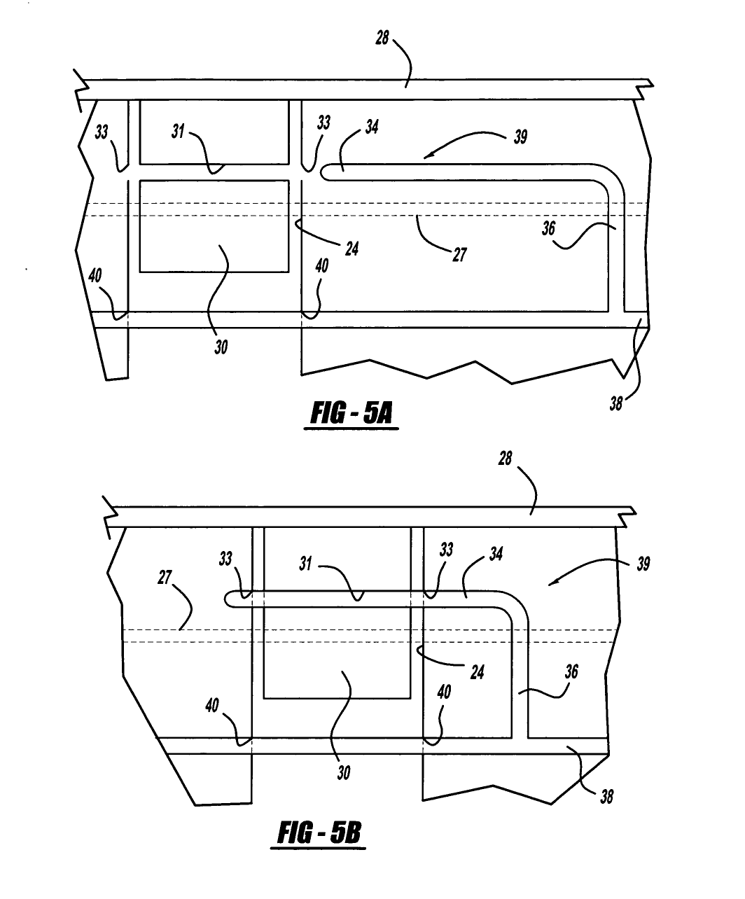

As shown generally in FIGS. 1a-5b, the base side walls 16, have receiving chambers, or receiving holes 24. In addition, it is preferred that the base side walls 16 have mounting holes 26 placed evenly across the length of the base side walls 16. It is also preferred that the base side walls 16 have a convex surface that creates a wheel well 27. A cap 28 is then placed on the base side walls 16; the cap 28 has what is commonly known as a class “A” surface. A class “A” surface is a high-gloss surface which is used in most automobiles to present an aesthetically pleasing appearance. Body sections of a vehicle such as the fenders, hood, roof, and doors commonly have a class “A” surface. The cap 28 has a class “A” surface to match with any surfaces which also have a class “A” surface. It is preferred that the cap 28 is connected to the base side walls 16 by extending bolts (not shown) or pins (not shown) through the holes 29 on the cap 28 and into the base side wall 16 through the mounting holes 26.

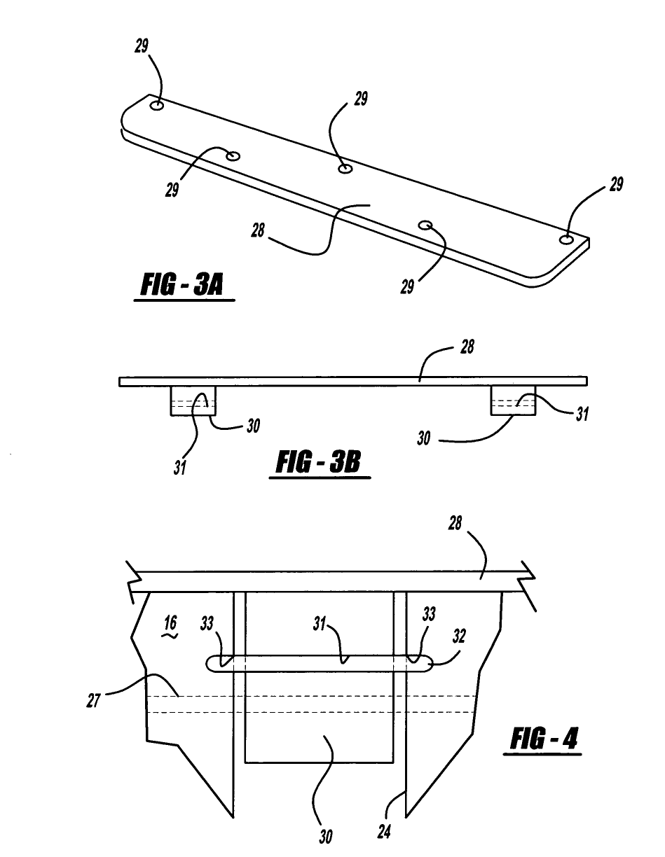

An alternate embodiment for attaching the cap 28 to the base side walls 16 would be to attach the cap 28 to the base side wall 16 with a typical hinge (not shown). Thus, the cap 28 could rotate about the hinge and rest against the inside of the base side wall 16, exposing the receiving holes 24 when access to the receiving holes becomes necessary. Another embodiment of the cap 28 is shown in FIG. 3b and FIGS. 4-5b. In this embodiment, the cap 28 has at least one rod 30 having a hole 31 where the rod 30 can be selectively inserted into one of the receiving holes 24. When the rod 30 is placed inside the receiving hole 24, the rod 30 can be locked by a pin 32 which extends through a pair of apertures 33 in the receiving hole 24 and the hole 31 in the rod 30. Access to the pin 32 is achieved underneath the wheel well 27. As previously stated, the truck 10 incorporating the present invention is of the heavy-duty type, larger in size and capable of towing large loads. Therefore, the wheel wells 27 are also larger in size and would allow access to a pin 32 used for securing a cap 28 according to the present invention. This embodiment is not limited to using the pin 32, other various fasteners could also be used to maintaining the position of the rod 30 in the receiving hole 24 may also be used. For example, a clevis pin or bolt attachment could be used.

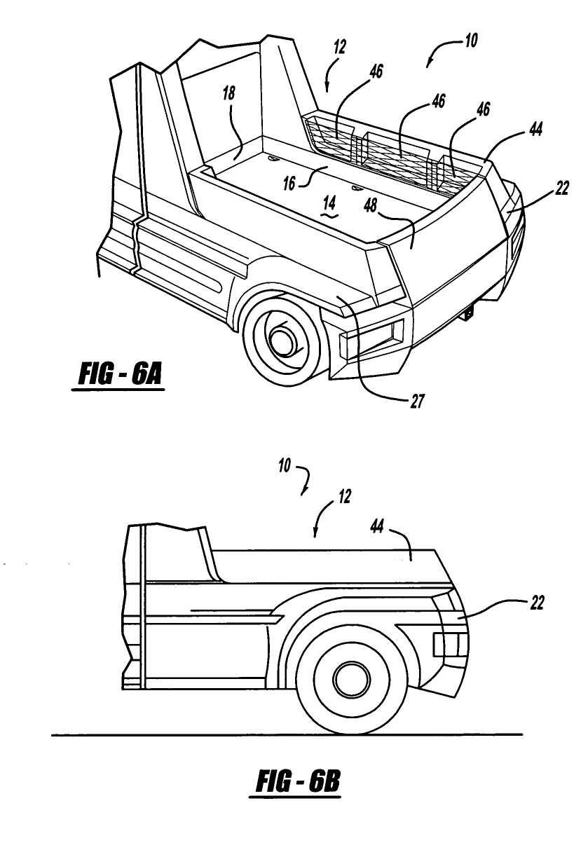

Another embodiment for connecting the cap 28 to the base side walls 16 is shown in FIGS. 5a and 5b. FIGS. 5a and 5b show a pin 34 connected to a shaft 36, the shaft 36 is connected to a common shaft 38; the common shaft 38 partially extends through the wheel well 27. The pin 34, the shaft 36, and common shaft 38 form a pin shaft assembly 39. The common shaft 38 has a handle (not shown) which is exposed underneath the wheel well 27 to allow access to the operator; the common shaft 38 extends through another set of apertures 40 in the receiving hole 24. The common shaft 38 also can include additional pins similar to pin 34 for being used in conjunction with additional rods 30 on the cap 28. Initially, when the rod 30 is first placed in the receiving hole 24, the common shaft 38 will be in the position shown in FIG. 5a. After the rod 30 is placed in the receiving hole 24, the common shaft 38 can slide through the apertures 40 in the receiving hole 24 such that the pin 34 will be placed through the receiving hole 24 in the rod 30. In addition, bolts (not shown) can be extended through the mounting holes 26 and into the cap 28 in order to secure the cap 28 to the base side walls 16.

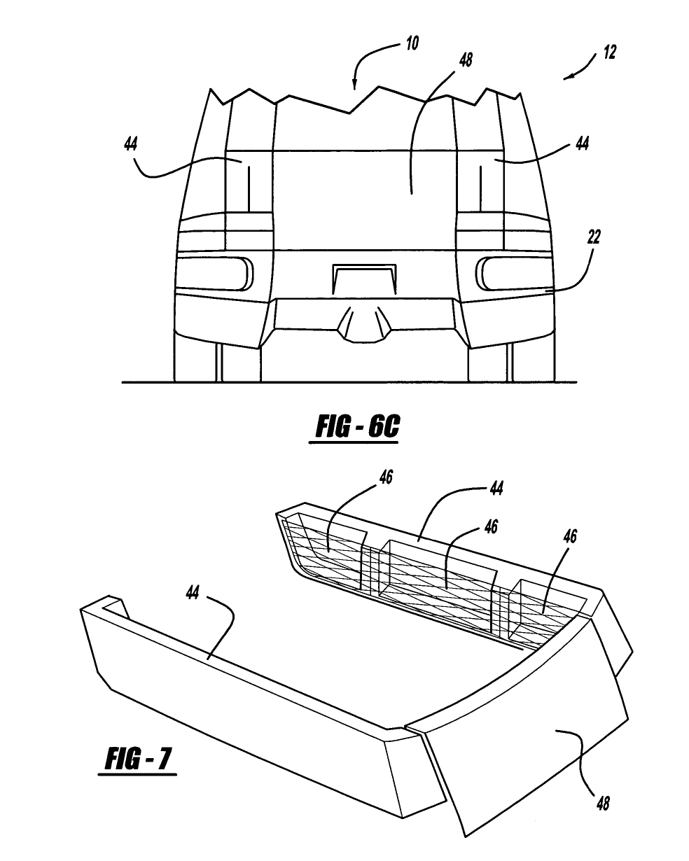

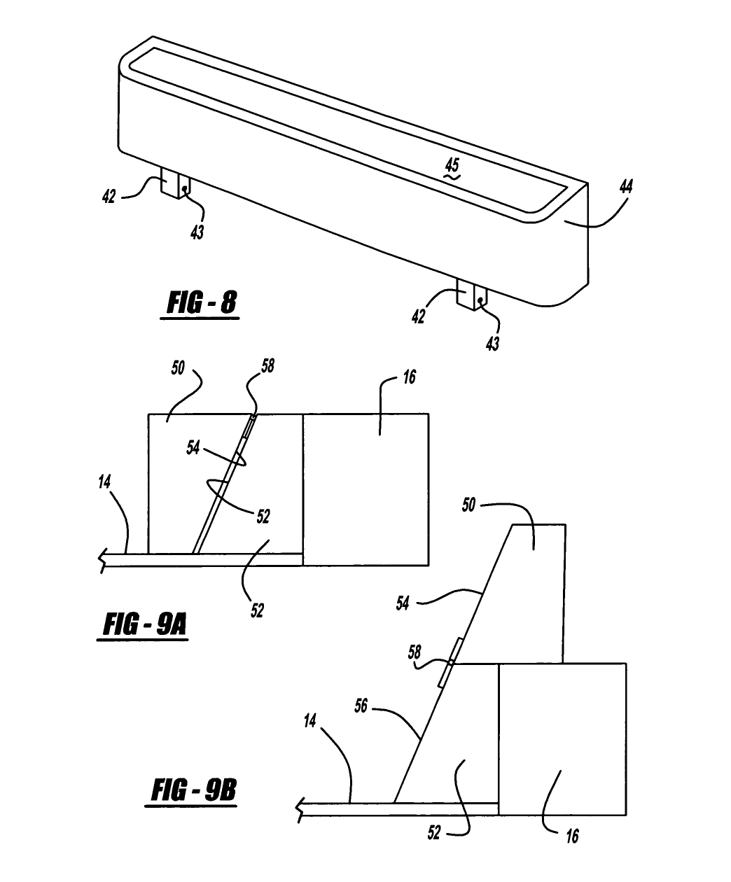

Referring to FIGS. 6a-8, the transformable truck bed 12 is shown in its transformed position, or second position. When the transformable truck bed 12 is in the transformed position, the transformable truck bed 12 still consists of the bed 14, base side walls 16, the base front wall 18, and the tail end 22. In addition, the transformable truck bed 12 has insert side walls 44 that replace the caps 28 on top of the base side walls 16 in order to improve the load carrying capacity of the truck bed 12. The insert side walls 44 shown in FIGS. 6a-8 are removable and can be used only when desired to do so by the operator. When the insert side walls 44 are installed, they rest upon the base side walls 16, and increase the overall height of the bed 12. The caps 28 are removed because the insert side walls 44 include extensions 42 having holes 43 that are placed into the receiving holes 24, securing the insert side walls 44 to the base side walls 16 in the same manner as the caps 28. It is also preferred that the receiving holes 24 are aligned along the longitudinal axis of the base side walls 16 so that the strain placed on the base side walls 16 by the insert side walls 44 via the extensions 43 is more evenly distributed about the base side walls 16. Furthermore, the insert side walls 44 can be equipped for use with additional fasteners (not shown) which can be extended through the mounting holes 26 and into corresponding holes (not shown) in the insert side walls 44 to provide additional support for the insert side walls 44 in order to satisfy various pay load requirements.

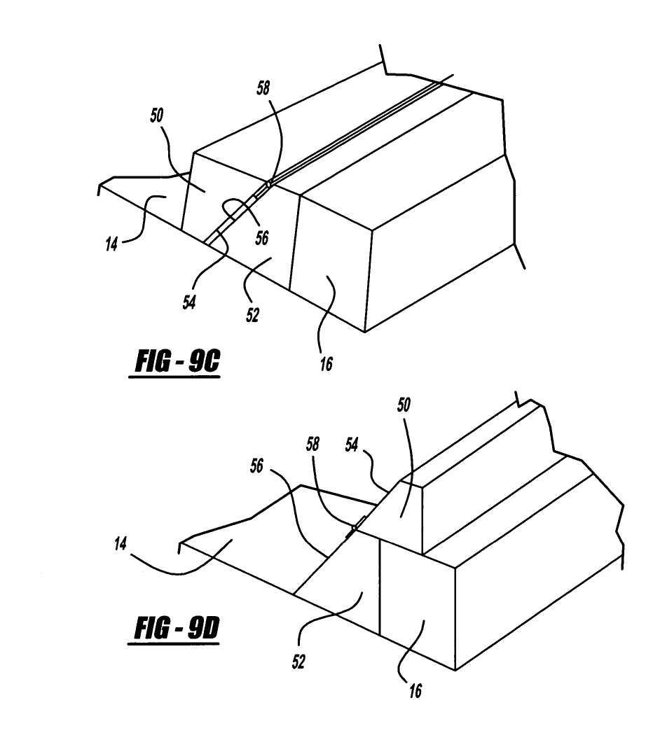

Like the caps 28, the insert side walls 44 can have any number of applications, either for aesthetic purposes, functional purposes, or a combination of aesthetic and functional purposes. For example, the interior side of the insert side walls 44 could have cargo net 46 such that the cargo net 46 could be used to form a single storage space, or multiple storage spaces, along the base side walls 16 and the insert side walls 44. Another application includes placing lighting units inside the insert side walls 44, which could be connected to the vehicle's power supply, in order to provide lighting to the bed 12, illuminating cargo, or for purely aesthetic purposes. Yet another embodiment, shown in FIG. 8, includes having the interior of the insert side wall 44 as a hollow structure, such that a cavity 45 is created. The cavity 45 can then be used as extra storage. Also, the cavity 45 allows for easier access to additional fasteners (not shown) extending through the insert side wall 44 and through the mounting holes 26, which can be used to fasten the insert side wall 44 to the base side wall 16, to provide additional support.

Moreover, when the insert side walls 44 are being used the base tailgate 20 is removed and replaced with an insert tailgate 48. Like the base tailgate 20, the insert tailgate 48 pivots about a set of primary hinges and is placed flush with the tail end 22. It is preferred that the top surface of the insert tailgate 48 is the same height as the insert side walls 44 in relation to the bed 14 so that the insert tailgate 48 and the insert side walls 44 are even.

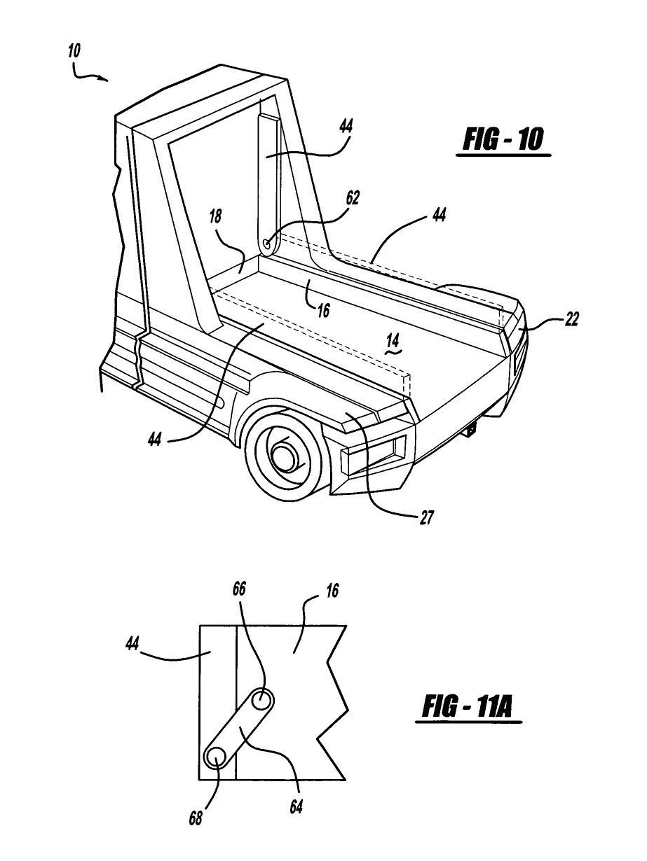

FIGS. 9a-9d show an alternate embodiment of the transformable truck bed 12. In this embodiment, there is a top side wall 50 which has an angled surface 52, and a bottom side wall 54 which also has an angled surface 56. The top side wall 50 is connected to the bottom side wall 54 through the use of a hinge connection 58. When the transformable truck bed 12 is in the stowed position, or first position, shown in FIGS. 9a and 9c, the top side wall 50 is adjacent to the bottom side wall 52, and the angled surface 54 along with the angled surface 56 are flush to one another. The hinge 58 allows the top side wall 50 to pivot relative to the bottom side wall 54 such that the top side wall 50 can be placed in the position shown in FIGS. 9b and 9d. Again, the angled surfaces 54 and 56 are aligned; however, once the top side wall 50 is placed in the position shown in FIGS. 9b and 9d, the angled surfaces 54 and 56 are no longer facing one another. It should be noted that the base side wall 16 is the same height as the bottom side wall 52, such that when the top side wall 50 pivots about the hinge 58, the top side wall 50 will rest on both the bottom side wall 52 and the base side wall 16.

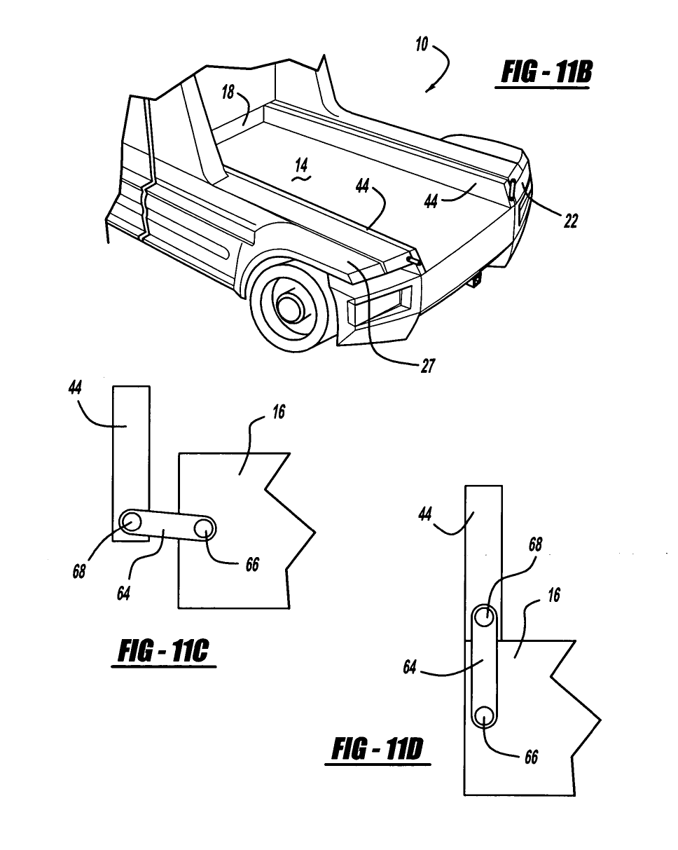

Referring to FIG. 10, another alternate embodiment is shown where the insert side walls 44 rotate about a pivot point 62. Thus, when the transformable truck bed 12 is in the first position, or stowed position, the insert side walls 44 are in an upright position along the base front wall 18. In this position, the insert side walls 44 are perpendicular to the bed 14. To place the transformable truck bed 12 in the second position, the insert side walls 44 are rotated about the pivot point 62 until the insert side walls 44 contact the base side wall 16. Thus, the insert side walls 44 are parallel to the bed 14, and are shown in this position in phantom in FIG. 10. In this embodiment, the insert side walls 44 increase the overall height of the transforming truck bed 12.

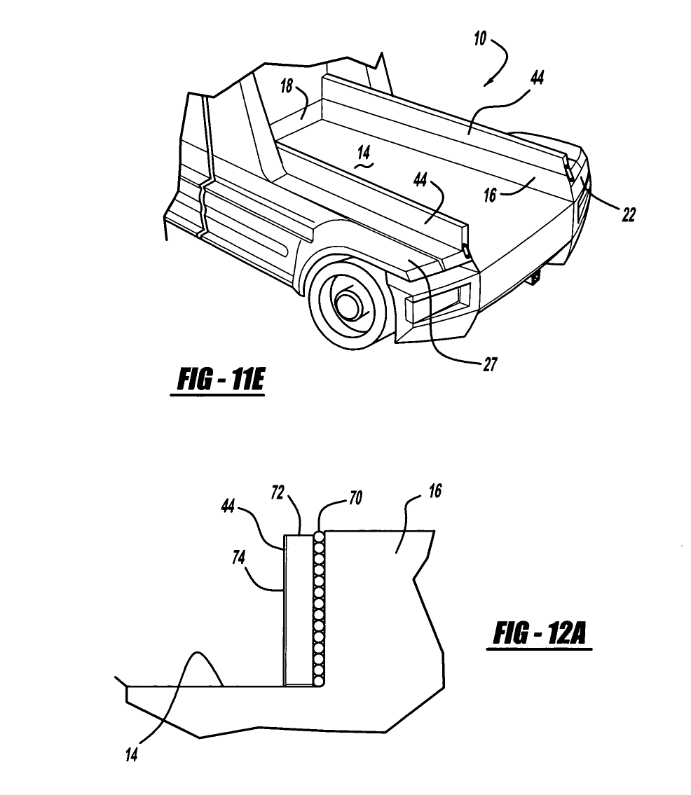

Another embodiment, shown in FIGS. 11a-11e, includes having the base side walls 16 connected to the insert side walls 44 via a pivot arm 64. The pivot arm 64 is connected to the base side wall 16 at approximately the midpoint of the base side wall 16 at a first connection point 66. Also, the pivot arm 64 is connected to the insert side wall 44 at the base of the insert side wall 44 at a second connection point 68. The pivot arm 64 is connected to the base side walls 16 and the insert side walls 44 by any suitable means, such that the connection points 66, 68 may be a pin or rivet, which will allow the pivot arm 64 to rotate about the connection points 66, 68. When the transformable truck bed 12 is in the stowed position, or first position, the insert side walls 44 are parallel to the base side walls 16, such that the insert side walls 44 are of the same height as the base side walls 16, best seen in FIGS. 11a and 11b. As the insert side walls 44 are moved from the first position to the second position, the insert side walls 44 will be in a position shown in FIG. 11c. As the transformable truck bed 12 is moved to the second position, shown in FIGS. 11d and 11e, the pivot arm 64 rotates about the connection points 66, 68, and the insert side wall 44 rotates until the bottom of the insert side wall 44 is flush with the top of the base side wall 16, and the insert side wall 44 along with the base side wall 16 are in a “stacked configuration”. Therefore, the height of the sides of the transformable truck bed 12, when it is in the second position, is the combined height of the base side wall 16 and the insert side wall 44. By contrast, when the transformable truck bed 12 is in the first position, the width of the base side wall 16 is increased by the width of the insert side wall 44.

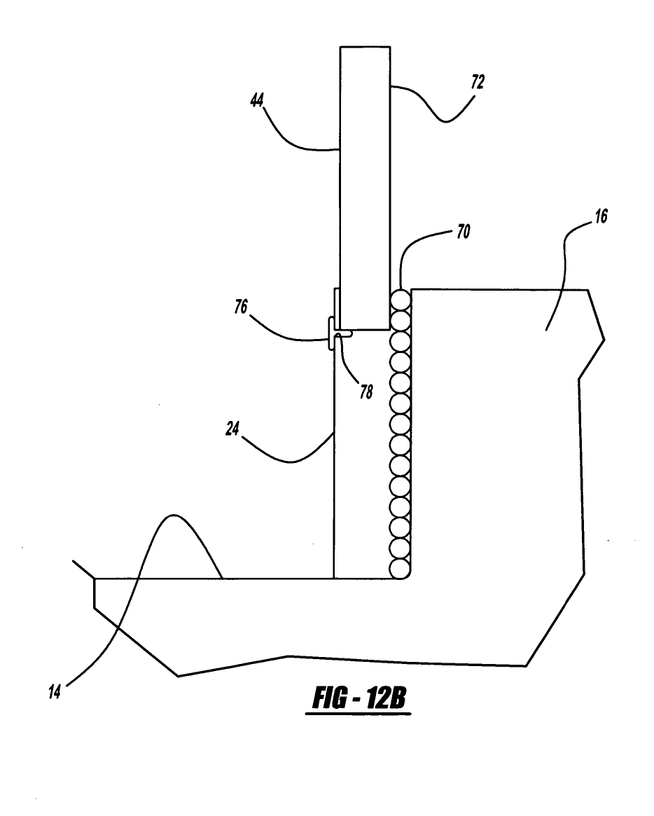

Another alternate embodiment of the present invention is shown in FIGS. 12a and 12b. In this embodiment the insert side wall 44 is comprised of a set of lockable ball bearings 70 which are used in conjunction with a first telescoping member 72 and a second telescoping member 74. The insert side wall 44 is in the stowed position, or first position, shown in FIG. 12a. The second telescoping member 74 is connected to the base side wall 16 by a common fastener (not shown), such as a screw. The first telescoping member 72 along with the ball bearings 70, are disposed within the second telescoping member 74. When the insert side wall 44 is to be moved from the first position in FIG. 12a, to the second position shown in FIG. 12b, the first telescoping member 72 is pulled out from within the second telescoping member 74 and rolls along the ball bearings 70. Once the first telescoping member 72 is in the position shown in FIG. 12b, a pin 76 is inserted through an aperture 78 in the second telescoping member 74, which will maintain the first telescoping member 72 in the position shown in FIG. 12b. FIG. 12b shows a single pin 76 holding the second telescoping member 74 in the second position, however, it is within the scope of the invention that multiple pins may be used for supporting the second telescoping member 74.

It is preferred that in any of the embodiments described above, where the insert side walls 44 are to be stowed in the transformable truck bed 12 when the transformable truck bed 12 is in the first position, a locking mechanism (not shown) is used to secure the insert side walls 44 in the stowed position. For example, a locking pin can extend through the pivot arm 62 and into either the insert side wall 44 or the base side wall 16 in order to prevent the pivot arm 62 from rotating about the connection points 66, 68 and at an undesirable time.

It should be noted that all of the exterior components, i.e., the bed 14, the base side walls 16, the base tailgate 22, the insert side walls 44, and the insert tailgate 48, can have a class “A” finish for providing an aesthetically pleasing appearance. In addition, any of the parts described above can be made of either steel or composite materials. The type of material selected can be based on the type of loading requirements.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A transformable truck bed comprising:
at least one base side wall;
a bed connected to said base side wall;
at least one insert side wall, operably associated with said at least one base side wall; and
wherein said at least one insert side wall is selectably engageable with said at least one base side wall to increase the overall height of said base side wall relative to said bed.

2. The transformable truck bed of claim 1, further comprising movable a cap for covering at least a portion of said at least one base side wall.

3. The transformable truck bed of claim 2, further comprising:
at least one hole in said base side wall;
at least one hole in said cap; and
wherein said cap is attached to said at least one base side wall by a fastener operably associated with said hole in said at least one base side wall, and said hole in said cap.

4. The transformable truck bed of claim 2, further comprising:
a least one receiving chamber located in said at least one base sidewall;
at least one aperture located in said at least one receiving chamber in proximity to said receiving hole;
at least one rod connected to said cap, said rod having a hole; and wherein said rod is received in said at least one receiving chamber of said at least one base side wall.

5. The transformable truck bed of claim 4, wherein said receiving chamber further comprises a pin, and said pin is inserted through said at least one aperture of said at least one receiving chamber and said hole in said at least one rod, securing said cap to said at least one base side wall.

6. The transformable truck bed of claim 4, further comprising:
a pin shaft assembly having at least one pin mounted on at least one shaft, said at least one shaft connected to a common shaft; and
wherein said at least one pin is selectively inserted into said hole in said rod and said at least aperture by way of said common shaft, securing said cap to said at least one base side wall.

7. The transformable truck bed of claim 1, wherein said at least one insert side wall further comprises a cargo net.

8. The transformable truck bed of claim 1, said at least one insert side wall further comprising at least one lighting unit.

9. The transformable truck bed of claim 1, wherein said at least one insert side wall further comprises a cavity.

10. The transformable truck bed of claim 1, further comprising a base tailgate operably associated with said base side wall, and an insert tailgate operably associated with said insert side wall.

11. The transformable truck bed of claim 1, wherein said at least one insert side wall further comprises:
a top side wall having an angled surface;
a bottom side wall having an angled surface; a hinge operably associated with said top side wall and said bottom side wall; and
wherein when said at least one insert side wall is in a first position, said top side wall is adjacent to the bottom side wall, and said angled surface of said top side wall is adjacent to said angled surface of said bottom side wall, and when said at least one insert side wall is in a second position, said top side wall will pivot about said hinge such that said angled surface of said top side wall and said angled surface of said bottom side wall form a continuous surface, and said top side wall is partially supported by said bottom side wall, and partially supported by said at least one base side wall.

12. The transformable truck bed of claim 1, wherein said at least one insert side wall is pivotably connected to said base side wall, such that when said at least one insert side wall is moved to a first position, said at least one insert side wall is substantially perpendicular to said bed, and when said at least one insert side wall is moved to a second position, said at least one insert side wall is substantially parallel to said bed and supported by said at least one base side wall.

13. The transformable truck bed of claim 1, further comprising:
a first telescoping member selectively disposed within a second telescoping member, said second telescoping member connected to said base side wall;
at least one bearing connecting said first telescoping member to said second telescoping member; and
wherein when said insert side wall is in said first position, said first telescoping member will be disposed within said second telescoping member, and when said insert side wall is moved to said second position, said first telescoping member will move along said at least one ball bearing relative to said second telescoping member.

14. The transformable truck bed of claim 1, further comprising a pivot arm pivotably connected to said at least one base side wall by a first connection point, and pivotably connected to said at least one insert side wall by way of a second connection point, and wherein when said at least one insert side wall is in a first position, said at least one insert side wall is adjacent to said at least one base side wall, and when said at least one insert side wall is moved to a second position, said pivot arm will pivot about said first connection point, and at least one insert side wall will pivot about said second connection point, and said at least one insert side wall is placed on top of said at least one base side wall.

15. A truck bed comprising:
at least one base side wall having at least one hole, and at least one receiving chamber, said receiving chamber having at least one aperture;
a bed connected to said at least one base side wall;
at least one insert side wall, operably associated with said receiving chamber or said at least one base side wall;
a cap having at least one hole, said cap operably associated with said at least one base side wall; and
wherein when said at least one insert side wall is placed in a first position, said cap is connected to said at least one base side wall, and when said at least one insert side wall is place in a second position, said cap is removed and said at least one insert side wall is positioned relative to said at least one base side wall to increase the overall height of said base side wall relative to said bed.

16. The truck bed of claim 15, where in said cap is secured to said base side wall by at least one fastener inserted through said at least one hole in said cap and said at least one hole in said base side wall.

17. The truck bed of claim 15, further comprising:
at least one rod having a hole, said rod connected to said cap and selectably received by said receiving chamber;
at least one extension having a hole connected to said at least one insert side wall, selectably received by said receiving chamber;
a pin selectably received by said hole in said rod and said at least one aperture in said receiving chamber; and
wherein when said rod of said cap is inserted into said receiving chamber, and said pin is inserted through said at least one aperture in said receiving chamber and said hole in said rod, said cap will be secured to said base side wall, and when said cap is removed from said base side wall and said extension of said of said insert side wall is inserted into said receiving chamber, and said pin is inserted into said at least one aperture and said hole of said extension, said insert side wall will be secured to said base side wall.

18. The truck bed of claim 15, further comprising:
at least one rod having a hole, said rod connected to said cap and selectably received by said receiving chamber;
at least one extension having a hole connected to said at least one insert side wall, selectably received by said receiving chamber;
a pin shaft assembly having at least one pin mounted on at least one shaft, said at least one shaft connected to a common shaft;
wherein said at least one pin is selectively inserted into said hole in said rod and said apertures of said at least one receiving chamber by way of said common shaft, securing the position of said cap to said at least one base side wall, and when said cap is removed from said base side wall and said extension of said of said insert side wall is inserted into said receiving chamber, and said pin is inserted into said apertures of said at least one receiving chamber and said hole in said extension by way of said common shaft, said insert side wall will be secured to said base side wall.

19. The truck bed of claim 15, wherein said at least one insert side wall comprises nylon netting to form at least one storage space.

20. The truck bed of claim 15, wherein said at least one insert side wall further comprises a cavity.

21. The truck bed of claim 15, wherein said at least one insert side wall further comprises at least one lighting unit.

22. The truck bed of claim 15, further comprising:
a base tailgate operably associated with said at least one base side wall;
an insert tailgate operably associated with said at least one insert side wall; and
wherein when said insert side wall is placed in said second position, said base tailgate is removed from said bed, and said insert tailgate is connected to said bed.

23. The truck bed of claim 15, wherein said insert side wall is comprised of a top side wall having an angled surface connected to said base side wall, and connected to a bottom side wall having an angled surface with a hinge, wherein when said at least one insert side wall is in a first position, said top side wall is adjacent to the bottom side wall, and said angled surface of said top side wall is adjacent to said angled surface of said bottom side wall, and when said at least one insert side wall is in a second position, said top side wall will pivot about said hinge such that said angled surface of said top side wall and said angled surface of said bottom side wall form a continuous surface, and said top side wall is partially supported by said bottom side wall, and partially supported by said base side wall.

24. The truck bed of claim 15, wherein said insert side wall is comprised of:
a pivot point rotatably connecting said insert side wall to said base side wall; and
wherein when said insert side wall is placed in a first position, said insert side wall is perpendicular to said base side wall, and when said insert side wall is placed in a second position, said at least one insert side wall will rotate about said pivot point until said at least one insert side wall is adjacent to said base side wall.

25. The truck bed of claim 15, wherein said at least one insert side wall comprises:
a first telescoping member selectably disposed within a second telescoping member, said second telescoping member connected to said base side wall;
at least one bearing connecting said first telescoping member to said second telescoping member; and
wherein when said insert side wall is in said first position, said first telescoping member will be disposed within said second telescoping member, and when said insert side wall is moved to said second position said first telescoping member will move along said at least one ball bearing relative to said second telescoping member to a height greater than said at least one base side wall.

26. The truck bed of claim 15, further comprising:
a pivot arm connected to said at least one base side wall at a first connection point, and connected to said at least one base side wall at a second connection point; and
wherein when said at least one insert side wall is in said first position, said insert side wall will be adjacent to said base side wall, and when said insert side wall is to be moved to said second position, said pivot arm will rotate relative to said first connection point and said second connection point, and said insert side wall and said base side wall will be in a stacked configuration.

27. A bed for a pick up truck, comprising:
at least one base side wall having a series of holes and a series of receiving chambers, said series of receiving chambers having an aperture extending through said series of receiving chambers, perpendicular to said receiving chambers;
at least one insert side wall, operably associated with said at least one base side wall;
a bed connected to said at least one base side wall; and
wherein said at least one insert side wall is moved relative to said at least one base side wall to increase the height of said at least one insert side wall relative to said bed.

28. The bed of claim 27, further comprising a cap for concealing at least a portion of said at least one base side wall.

29. The bed of claim 28, wherein said cap includes a series of holes which align with said series of holes on said base side wall, and are received by a series of fasteners for affixing said cap to said at least one base side wall.

30. The bed of claim 28, further comprising:
a series of rods having a hole connected to said cap;
a series of extensions having a hole, said series of extensions connected to said at least one insert side wall;
a pin for selectably being inserted into said hole in said series of rods, or said hole in said series of extensions; and
wherein when said pin is inserted into said hole of said series of rods and said aperture of said receiving chambers, said cap will be secured to said at least one base side wall, and when said cap is removed and said series of extensions are inserted into said series of receiving chambers and said pin is inserted into said aperture of said receiving chambers and said hole in said series of extensions, said at least one insert side will be secured to said at least one base side wall.

31. The bed of claim 28, further comprising:
a series of rods having a hole connected to said cap;
a series of extensions having a hole, said series of extensions connected to said at least one insert side wall;
a pin shaft assembly having at least one pin mounted on at least one shaft, said at least one shaft connected to a common shaft;
wherein when said at least one pin is inserted into said hole of said series of rods and said aperture of said series of receiving chambers, said cap will be secured to said at least one base side wall, and when said cap is removed and said series of extensions are inserted into said series of receiving chambers and said at least one pin is inserted into said aperture of said receiving chambers and said hole in said series of extensions, said at least on insert side wall will be secured to said at least one base side wall.

32. The bed of claim 27, wherein said at least one insert side wall includes nylon netting forming at least on storage space.

33. The bed of claim 27, further comprising at least one lighting unit for illuminating said bed.

34. The bed of claim 27, said at least one insert side wall further comprises:
a top side wall having an angled surface connected to a bottom side wall having an angled surface;
a hinge connected to said angled surface of said top side wall and to said angled surface of said bottom side wall; and
wherein when said at least one insert side wall is in a first position, said top side wall is adjacent to the bottom side wall, and said angled surface of said top side wall is adjacent to said angled surface of said bottom side wall, and when said at least one insert side wall is in a second position, said top side wall will pivot about said hinge such that said angled surface of said top side wall and said angled surface of said bottom side wall form a continuous surface, and said top side wall is partially supported by said bottom side wall, and partially supported by said at least one base side wall.

35. The bed of claim 27, wherein said insert side wall further comprises:
a pivot point connecting said at least one insert side wall to said at least one base side wall; and
wherein when said insert side wall is rotated about said pivot point to change the position of said insert side wall relative to said base side wall, such that said insert side wall can be moved from a perpendicular position relative to said base side wall to a parallel position relative to said base side wall.

36. The bed of claim 27, wherein said insert side wall comprises:
a first telescoping member selectably disposed within a second telescoping member, said second telescoping member connected to said base side wall;
at least one bearing connecting said first telescoping member to said second telescoping member; and
wherein when said insert side wall is in said first position, said first telescoping member will be disposed within said second telescoping member, and when said insert side wall is moved to said second position said first telescoping member will moving along said at least one ball bearing relative to said second telescoping member.

37. The truck bed of claim 27, further comprising:
a pivot arm connected to said at least one base side wall at a first connection point, and connected to said at least one base side wall at a second connection point; and
wherein when said at least one insert side wall is in said first position, said insert side wall will be adjacent to said base side wall, and when said insert side wall is to be moved to said second position, said pivot arm will rotate relative to said first connection point and said second connection point, and said insert side wall and said base side wall will be in a stacked configuration.
